(19) United States
(12) Patent Application Publication
(10) Pub. No.: US 2006/0264577 A1
(43) Pub. Date: Nov. 23, 2006

(54) Capping reactions in cationic polymerization; kinetic and synthetic utility

(76) Inventors: Rudolf Faust, Lexington, MA (US); Priyadarsi De, Lowell, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/400,059

(22) Filed: Apr. 7, 2006

Related U.S. Application Data
(60) Provisional application No. 60/676,745, filed on May 2, 2005.
(60) Provisional application No. 60/674,649, filed on Apr. 25, 2005.
(60) Provisional application No. 60/669,739, filed on Apr. 8, 2005.

(51) Int. Cl. C08F 297/02

(52) U.S. Cl. 525/242; 525/333.7

(57) ABSTRACT

A method of synthesizing an endcapped polymer, comprising reacting in a solvent a cationic living polymer with an optionally substituted conjugated diene as an endcapping reagent, whereby the solvent causes termination by halogenation to be faster than the addition of additional molecules of the conjugated diene, thereby producing an endcapped polymer having a halogenated endcap group.

### RELATED APPLICATIONS

This application claims the benefit of U.S. Provisional Application No. 60/676,745, filed on May 2, 2005, U.S. Provisional Application No. 60/674,649, filed on Apr. 25, 2005, and U.S. Provisional Application No. 60/669,739, filed on Apr. 8, 2005.

This Application also claims the benefit of U.S. Provisional Application No. ______, filed under the attorney docket number 0813.2010-000 on the even date herewith.

The entire teachings of the above applications are incorporated herein by reference.

### GOVERNMENT SUPPORT

The invention was supported, in whole or in part, by a grant CHE-0131106 from the National Science Foundation. The Government has certain rights in the invention.

### BACKGROUND OF THE INVENTION

Living polymerizations that proceed in the absence of termination and chain transfer are a most desirable objective of the synthetic polymer chemist. The living polymerization of olefins is a method that can be used to control molecular weight and final product properties in polymers. The polymerizations are called living because the initiators typically grow only one chain per initiator molecule and the polymerization continues until monomer is exhausted, rather than terminating when the chain reaches a certain length or the initiator is exhausted. Living polymerizations can yield polymers wherein structure, molecular weight, molecular weight distribution and chain end functionalities can be well-defined and controlled.

While considerable accomplishments have been made in living carbocationic polymerizations to control molecular weight and molecular weight distribution, and advances have been made in the synthesis of block copolymers by sequential monomer addition, success remains limited in the synthesis of functional polymers by in situ functionalization of the living ends. The lack of success in these areas is believed to be due to the nature of living cationic polymerization. In contrast to anionic living polymerization, in cationic living polymerizations the concentration of active species (the concentration of cations) can be extremely small, with most of the chain ends typically being in a dormant form. For instance, in the living polymerization of isobutylene with alkyl halide/BCl₃ or TiCl₄ initiating systems, the dormant form can be the chloro-terminated species (that however can be reactivated). Quenching with nucleophiles that also react with the Lewis acid e.g. TiCl₄ etc. therefore can result in tertiary chloro-terminated polymers that generally exhibit low reactivity. Typically, only a negligible portion of chain ends that are in ionic form at the introduction of the nucleophile can be functionalized.

Functional polymers find applications in many areas, e.g. as seal and adhesives, coatings, etc. U.S. Pat. No. 5,677,836 to Faust, the entire teachings of which are incorporated herein by reference, discloses capping of living cationic polymers with substituted or unsubstituted diphenyl alkylene. Capping (quantitative monoaddition of diarylethylenes) can result in a stable cation that can be functionalized by quenching with soft π-nucleophiles. Diarylethylenes, however, can be expensive especially when low molecular weight functional polymers are desired.

Therefore, a need exists to develop new methods of functional polymer synthesis.

Furthermore, the reactivity of the chloroallyl end-group may not be sufficiently high in some application. For instance attempts to produce block copolymers by the coupling of living poly(methyl methacrylate) anions and chloroallyl end functional polyisobutylene (PIB-BD-Cl) remained unsuccessful. Similarly, the initiator efficiency of PIB-BD-Cl in atom tranfer radical polymerization can be rather low. Therefore the need exist to find more reactive end-groups.

### SUMMARY OF THE INVENTION

It has now been discovered that polyisobutylene can be successfully end capped by a chloroallyl group when the reaction between living polyisobutylene and 1,3-butadiene is carried out in certain solvents. It has further been discovered that polyisobutylene can be successfully end capped by bromoallyl groups. As used herein, the term “capping” means termination of polymerization reaction by essentially quantitative monoaddition of butadiene to a polymer chain.

In one embodiment, the present invention is a method of synthesizing an endcapped polymer. The method comprises reacting in a solvent a cationic living polymer with an optionally substituted conjugated diene as an endcapping reagent, whereby the solvent causes termination by halogenation to be faster than the addition of additional molecules of the conjugated diene, thereby producing an endcapped polymer having a halogenated endcap group.

In another embodiment, a method of synthesizing an endcapped polymer of the present invention comprises reacting in a solvent a polymer of formula (I) 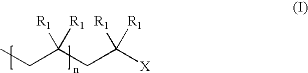
with an optionally substituted conjugated diene of formula (II) as an endcapping reagent in the presence of a Lewis acid, 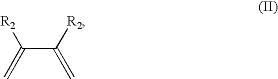
whereby the solvent causes termination by halogenation to be faster than the addition of additional molecules of the conjugated diene, thereby producing an endcapped polymer of formula (III) having a halogenated endcap group 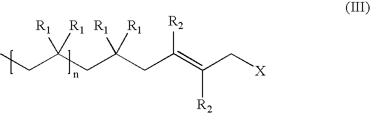
In formulas (I) to (III) n is not less than 2, X is a halogen, R₁ for each occasion is independently H or a C1-C4 alkyl, and R₂ for each occasion is independently H, a halogen, CH₂X, CHX₂, —CX₃, —C≡N, —NO₂.

As used herein, the term “Lewis acid” means an electron pair acceptor, such as BCl₃ or TiCl₄.

In another embodiment, a method of synthesizing an endcapped polymer the present invention comprises reacting a polymer of formula (IV) 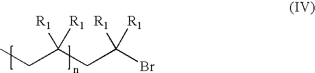
with an optionally substituted conjugated diene of formula (II) as an endcapping reagent in the presence of a Lewis acid, 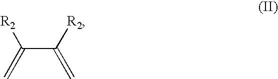
thereby producing an endcapped polymer of formula (V) having a halogenated endcap group, 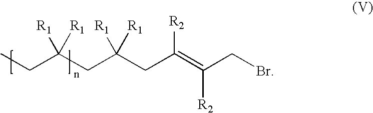
In formulas (IV) and (V), n is not less than 2, R₁ for each occasion is independently H or a C1-C4 alkyl, and R₂ for each occasion is independently H, a halogen, —CH₂X, —CHX₂, —CX₃, —C≡N, —NO₂.

One advantage offered by the method of the present invention is a very high yield of the monoaddition product (up to 100%). Another advantage of the present invention is that polyisobutylene capped by a bromoallyl group offers reactivity that is higher than that of the previously reported chloroallyl end groups.

### DETAILED DESCRIPTION OF THE INVENTION

The present invention provides a process to produce capped polyolefin polymers and the products obtained. In various embodiments, this invention provides a method to “cap” a living polyolefin cation, typically a polyisoolefin cation, even more typically a living polyisobutylene cation (PIB⁺), with a capping agent.

A capping agent can include optionally substituted olefins, generally optionally substituted conjugated dienes, typically optionally substituted butadienes, even more typically unsubstituted butadiene.

In various embodiments, the living polyolefin is any polyolefin with a terminal cationic group. Typically these polyolefins are those that are made by living polymerization methods known to those of ordinary skill in the art.

In various embodiments, polyolefin, e.g., polyisoolefin, polymultiolefin or poly(substituted or unsubstituted vinylidene aromatic compounds) more typically polyisobutylene, can be reacted with optionally substituted conjugated diene, e.g., butadiene, to “cap” the polymer, wherein the cap is halide terminated group.

Polyolefins can include C₄ to C₁₈ polyisomonoolefins, C₄ to C₁₄ polymultiolefins, and poly(substituted or unsubstituted vinylidene aromatic compounds), for example C₄ to C₁₀ polyisomonoolefins, or more typically C₄ to C₈ polyisomonoolefins. Polyisobutylene is an example of a preferred isoolefin polymer.

One set of reaction conditions that can produce these polymeric carbocations is, in a solvent, to contact the olefin monomer with an initiating system comprising an initiator (usually an organic ether, organic ester, or organic halide) and a co-initiator. The co-initiator is typically used in concentrations equal to or typically 2 to 40 times higher than the concentration of the initiator. Examples of co-initiators include one or more of BCl₃, TiCl₄, AlBr₃, and organoaluminum halides such as Me₃Al₂Br₃, MeAlBr₂, and Me₂AlBr.

The polymerization can typically be conducted in a temperature range of from about −10° to about −100° C., typically from about −50° to about −90° C. for about 10 to about 120 minutes depending on the concentration of the initiator and the co-initiator.

Once the desired living polymer is obtained, the capping agent, e.g., optionally substituted butadiene can be added to the polymerization media in concentrations equal up to about 10 times the concentration of the living chain ends, typically about 1 to about 5 times the concentration of the living chain ends, even more typically about 1 to about 2 times the concentration of the living chain ends. The butadiene can be allowed to react with the living polymer for about 10 minutes to about 5 hours, depending on the concentration of the concentration of the living chain ends and the butadiene.

A preferred method for obtaining 100% capping is simply to wait. The time to wait will vary with the initiator, co-initiator and butadiene concentrations. With higher initiator concentrations the time is shorter, about 20 minutes, while lower initiator concentrations may require 10 hours to achieve 100% capping.

In preferred embodiments the polymerization processes of this invention (polymerizing monomer to make living polymer) may be conducted in a polymerization zone of a conventional polymerization apparatus, in the presence or in the absence of a diluent. Suitable polymerization conditions include a temperature ranging from about −100° C. to about 10° C., typically from about −80° C. to about 0° C. for a time period ranging from about 1 to about 180 minutes. Typically, the polymerization reaction mixture may be subjected to agitation, e.g., using conventional mixing means.

The living polymers of the present invention may be homopolymers, copolymers, terpolymers, and the like depending upon the olefinic chargestock used.

Preferred number average molecular weights (Mn) of the living polymers of the present invention may range from about 500 to about 2,000,000, generally from about 2,000 to about 100,000, or in some embodiments from about 1500 to about 5000. The polymers have a narrow molecular weight distribution such that the ratio of weight average molecular weight to number average molecular weight (M_{w}/Mₙ) of the polymers ranges from about 1.0 to about 1.5, typically from about 1.0 to about 1.2. The polymers may be recovered from the polymerization zone effluent and finished by conventional methods.

In one embodiment, the present invention is synthesizing an endcapped polymer resulting in a very high yield (up to 100%) of a functionalized monoaddition product of butadiene to the polymer chain.

Specifically, scheme (I) illustrates one embodiment of the process of the present invention exemplified by monoaddition of 1,3-butadiene to a living polyisobutylene chain resulting in capping of the growing polymer chain by a chloroallylic group.

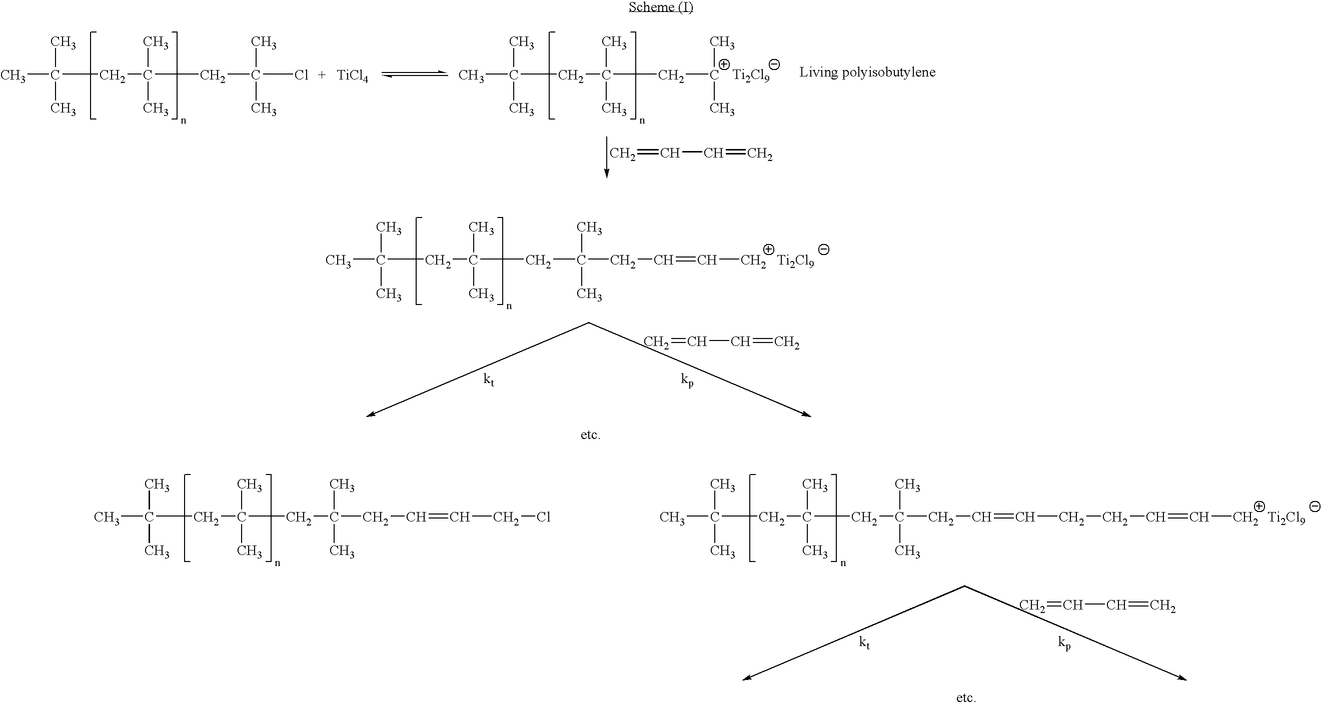

In one embodiment, selected conditions have been discovered under which termination is faster than propagation of butadiene (kₜ>>kₚ), resulting in carbocations reacting with olefins to yield the [1:1] adduct exclusively.

As used herein, the term “faster” means at least 10-fold faster, preferably at least 100-fold faster, more preferably 1000-fold faster.

The conditions, under which the reactions of the present invention can be carried out include carrying out the reactions in a solvent that causes termination by halogenation to be faster than the addition of additional molecules of the conjugated diene to carbocation (1) in Scheme (I), thereby producing an endcapped polymer having a halogenated endcap group.

An example of a reaction of the present invention is reacting in a solvent a polymer of formula (I) 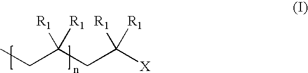
with an optionally substituted conjugated diene of formula (II) as an endcapping reagent in the presence of a Lewis acid, 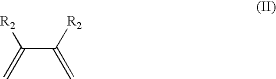
thereby producing an endcapped polymer of formula (III) having a halogenated endcap group

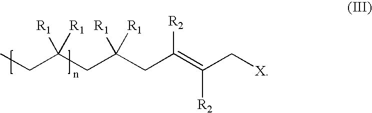

In formulas (I) through (III),

n is an integer not less than 2;

X is a halogen (F, Cl, Br, or I);

R₁ for each occasion is independently H or a C1-C4 alkyl; and

R₂ for each occasion is independently H or an electron-withdrawing group.

As used herein, the term “alkyl” includes straight or branched, optionally substituted saturated monovalent hydrocarbon radicals. Examples of alkyl groups include, but are not limited to, methyl, ethyl, propyl, isopropyl, and t-butyl. Suitable substituents for a substituted alkyl include halogen, cyano, nitro, a C1-C3 alkyl, C1-C3 haloalkyl.

Examples of electron-withdrawing groups include a halogen, CH₂X, CHX₂, —CX₃, —C≡N, —NO₂.

Solvents suitable for practicing the reactions of the present invention include solvents that comprise at least one component having a dielectric constant less than 9. Preferably, the solvents comprise at least one component having a dielectric constant less than 7. Alternatively, the solvents comprise a mixture of solvents having a polar solvent with a dielectric constant equal to or higher than 9 and a nonpolar solvent with a dielectric constant lower than 6. Examples of suitable solvents include one or more of hexane, cyclohexane, methylcyclohexane, methylchloride, n-butyl chloride, dichloromethane, toluene, and chloroform.

In another embodiment, the present invention is a method of synthesizing a bromoallyl-capped polymer. Example of this embodiment is reacting a polymer of formula (IV) 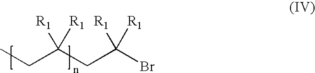
with an optionally substituted conjugated diene of formula (II) as an endcapping reagent in the presence of a Lewis acid, 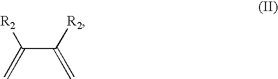
thereby producing an endcapped polymer of formula (V) having a halogenated endcap group 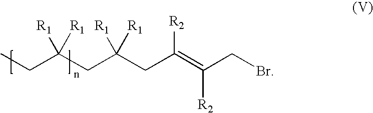
The variable in formulas (IV) and (V) are as defined above with respect to formulas (I) through (Ell).
Exemplification

### EXAMPLE 1

### Capping Reactions in Cationic Polymerization

Materials

Methyl chloride (MeCl) and isobutylene (IB) were dried in the gaseous state by passing them through in-line gas-purifier columns packed with BaO/Drierite. They were condensed in the cold bath of a glove box prior to polymerization. Titanium tetrachloride (TiCl₄, Aldrich, 99.9%), 2,6-di-tert-butylpyridine (DTBP, Aldrich, 97+%), 1,3-butadiene (BD, Aldrich, 99+%), Aluminum bromide (AlBr₃, 1.0 M solution in dibromomethane, Aldrich), Trimethylaluminum (Me₃Al, 2.0 M solution in hexanes, Aldrich) were used as received. Methylaluminum sesquibromide (Me₃Al₂Br₃), methylaluminum dibromide (MeAlBr₂), and dimethylaluminum bromide (Me₂AlBr) was obtained by mixing AlBr₃ and Me₃Al solutions respectively in 1: 1, 2:1 and 1:2 ratio at room temperatures. The 2-chloro-2,4,4-trimethylpentane (TMPCl) was synthesized according to the literature. Hexanes (Hex, Doe & Ingals, Technical grade) was refluxed for 60 hours with concentrated sulfuric acid. It was washed three times with 10% NaOH and then with distilled water repeatedly until neutral. After drying overnight over anhydrous Na₂SO₄, it was refluxed under nitrogen overnight with calcium hydride (CaH₂) for 24 hours and distilled to a round bottom flask containing CaH₂. It was again refluxed overnight with CaH₂ under nitrogen and distilled just before use. Methanol (MeOH, Doe & Ingals, Technical grade) was purified by simple distillation.

Polymerization

Polymerizations were carried out under a dry nitrogen atmosphere ([H₂O]<0.5 ppm) in an MBraun 150-M glove box (Innovative Technology Inc., Newburyport, Mass.). Large (75 mL) culture tubes were used as polymerization reactors (equipped with Teflon-lined caps). Throughout the study IB was considered as apolar solvent and its volume was added to the volume of hexanes. The total volume of the reaction mixture was 20 mL or 25 mL.

The AlBr₃ and Me₃Al was mixed in different ratio in hexanes at room temperature and kept for 10 minutes. Required amounts of this stock solution were added very slowly to the culture tubes at −80° C. containing hexanes, DTBP and MeCl. It was stirred thoroughly and kept at −80° C. for 30 minutes. The polymerization of IB was initiated by adding the mixture of IB and initiator stock solution. After predetermined time, polymerization was terminated by the addition of 1.0 mL prechilled methanol. The polymer was recovered and purified two times by reprecipitation from hexanes/methanol. Monomer conversions were determined by gravimetric analysis.

In a typical experiment, the capping reaction of PIB⁺ cation with BD was carried out in Hex/MeCl 60/40 (v/v) at −80° C. using the following concentrations: [TMPCl]=0.002 mol L⁻¹, [DTBP]=0.004 mol L⁻¹, [IB]=0.25 mol L⁻¹, [Me₃Al₂Br₃]=0.004 mol L⁻¹, and [BD]=0.04 mol L⁻¹. Into a 75-mL culture tube at −80° C. 10.9 mL Hex at room temperature, 8.0 mL MeCl at −80° C., 0.4 mL DTBP stock solution in Hex (0.2 mol L⁻¹) at −80° C. were added and mixed thoroughly and kept at −80° C. 1.0 mL 1:1=AlBr₃:Me₃Al mixture in Hex at room temperature (0.09 mol L⁻¹ stock solution) was added the culture tube and mixed thoroughly and kept at −80° C. The polymerization of IB was initiated under stirring at −80° C. by adding 1.0 mL mixture of IB and TMPCl stock solution (where TMPCl concentration was 0.04 mol L⁻¹ and IB concentration was 5.0 mol L⁻¹ in Hex at −80° C.). After 3 minutes of IB polymerization, one of the tubes was quenched with 1.0 mL prechilled methanol for the characterization of original PIB, and to the rest 0.5 mL of BD (1.6 mol L⁻¹, in Hex/MeCl 60/40 (v/v) at −80° C.) was added under stirring. After predetermined times, parallel runs were terminated by the addition of 1.0 mL prechilled methanol at −80° C.

Characterization

Molecular weights were measured with a Waters HPLC system equipped with a model 510 HPLC pump, model 410 differential refractometer, model 441 absorbance detector, on-line multiangle laser light scattering (MALLS) detector (MiniDawn, Wyatt Technology Inc.), Model 712 sample processor, and five Ultrastyragel GPC columns connected in the following series: 500, 10³, 10⁴, 10⁵, and 100 Å. Tetrahydrofuran (THF) was used as eluent at a flow rate of 1.0 mL/min at room temperature. The measurements were carried out at room temperature. The NMR spectroscopy was carried out on a Bruker 500 MHz spectrometer using CDCl₃ as a solvent (Cambridge Isotope Lab., Inc.). The ¹H and ¹³C NMR spectra of solutions in CDCl₃ were calibrated to tetramethylsilane as internal standard (δ_{H} 0.00) or to the solvent signal (δ_{C} 77.0), respectively.

Capping Reaction of Living PIB⁺ Cation with 1,3-Butadiene in Hexanes/MeCl 60/40 (v/v) at −80° C.

First, IB was polymerized in hexanes/MeCl 60/40 (v/v) at −80° C. using [IB]=0.13 M, [TMPCl]=0.004 M, [DTBP]=0.004 M and [TiCl₄]=0.036 M for 60 minutes (conversion of IB=100%, M_{n,GPC}=2200, M_{n,NMR}=2240, PDI=1.16) and then BD at −80° C. was added under stirring and after different time, the reaction was quenched with prechilled methanol. Quantitative crossover reaction from living PIB chain end to 1,3-butadiene followed by instantaneous termination (absence of multiple addition of BD) and selective formation of 1,4-addition product was obtained (M_{n,GpC}=2200, M_{n,NMR}=2380, PDI=1.11) using [BD]=0.05 M in 4 h. The NMR analysis of the product shows the exclusive formation (>99%) of 1,4-addition product:

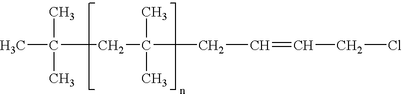

### EXAMPLE 2

### Butadiene Caps 1100% of CumCl/TiCl₄ Initiated Chains

Isobutylene (IB) was polymerized for 60 minutes in hexanes/MeCl 60/40 (v/v) at −80° C. by employing cumyl chloride/titanium tetrachloride (CumCl/TiCl₄) as the initiating system and DTBP as a proton trap. The reaction conditions were as follows: [IB]=0.13 mol/L, [CumCl]=0.003 mol/L, [DTBP]=0.004 mol/L and [TiCl₄]=0.036 mol/L.

After 60 minutes of polymerization, (conversion of IB=100%, M_{n,GPC}=2680, M_{n,NMR}=2650, PDI=1.13) the capping agent butadiene ([BD]=0.05 mol/L) was added to the reaction mixture and after capping times ranging from 60 to 240 minutes, the reaction was quenched with prechilled methanol. 100% capping was obtained after 240 minutes.

### EXAMPLE 3

### Butadiene Caps 100% of Chains in Large Scale Reactions

A large-scale experiment was carried out to prepare PIB capped with BD, starting with a higher concentration of IB compared to Examples 1-2. First, IB was polymerized using the TMPCl/TiCl₄ initiating system in hexanes/MeCl 60/40 (v/v) at −80° C. The conditions employed were [IB]=0.3 mol/L, [TMPCl]=0.004 mol/L, [DTBP]=0.004 mol/L and [TiCl]=0.036 mol/L.

After 60 minutes of polymerization (conversion of IB=100%, M_{n,GPC}=4600, M_{n,NMR}=4400, PDI=1.06), the capping agent butadiene ([BD]=0.05 mol/L) was added to the reaction mixture at −80° C. and after 250 minutes, the reaction was quenched with 50 mL methanol at −80° C.

Analysis of the NMR spectra shows formation of more than 99% 1,4-addition product in the final PIB-BD.

### EXAMPLE 4

### Mono-Addition of Butadiene (BD) takes Place even when Virtually Stoichiometric Amount of BD was Employed

First, IB was polymerized for 1 h by TMPCl/TiCl₄ initiating system in hexanes/MeCl 60/40 (v/v) solvent mixture at −80° C. using [IB]=0.65 mol L⁻¹, [TMPCl]=0.02 mol L⁻¹, [DTBP]=0.004 mol L⁻¹ and [TiCl₄]=0.036 mol L⁻¹ BD ([BD]=0.021 mol L⁻¹) at −80° C. was added slowly under stirring and after different polymerization time, the reaction was quenched with prechilled methanol. Detailed analysis of the NMR spectra shows that 100% capping was obtained in 20 hours.

### EXAMPLE 5

### Complete Mono-Addition of Butadiene (BD) takes Place even with [2-chloro-2,4,4-trimethylpentane (TMPCl)]/[TiCl₄>1

First, IB was polymerized for 1 h by TMPCl/TiCl₄ initiating system in hexanes/MeCl 60/40 (v/v) at −80° C. using [IB]=1.3 mol L⁻¹, [TMPCl]=0.04 mol L⁻¹, [DTBP]=0.004 mol L⁻¹ and [TiCl₄]=0.036 mol L⁻¹ and then BD ([BD]=0.05 mol L⁻¹) at −80° C. was added under stirring and after different polymerization time, the reaction was quenched with prechilled methanol. Detailed analysis of the NMR spectra shows that 100% capping was obtained in less than 10 h.

### EXAMPLE 6

### Preparation of High Molecular Weight Products

The IB concentration was increased to [IB]=2.0 mol L⁻¹ from [IB]=0.13 mol L⁻¹ and all other conditions were identical to Example 1. First IB was polymerized for 1 h by TMPCl/TiCl₄ initiating system in hexanes/MeCl 60/40 (v/v) at −80° C. using [IB]=2.0 mol L⁻¹, [TMPCl]=0.004 mol L⁻¹, [DTBP]=0.004 mol L⁻¹ and [TiCl₄]=0.036 mol L⁻¹ (conversion of IB=100%, M_{n,GPC}=28400, M_{n,NMR}=29100, PDI=1.14) and then BD ([BD]=0.05 mol L⁻¹) at −80° C. was added under stirring and after different time, the reaction was quenched with prechilled methanol. Detailed analysis of the NMR spectra shows that 100% capping was obtained in 240 minutes.

The IB concentration was increased to [IB]=4.0 mol L⁻¹ from [IB]=0.13 mol L⁻¹, all other conditions were identical to Example 1. First IB was polymerized for 1 h by TMPCl/TiCl₄ initiating system in hexanes/MeCl 60/40 (v/v) at −80° C. using [IB]=4.0 mol L⁻¹, [TMPCl]=0.004 mol L⁻¹, [DTBP]=0.004 mol L⁻¹ and [TiCl₄]=0.036 mmol L⁻¹ (conversion of IB=100%, M_{n,GPC}=53000, M_{n,NMR}=55100, PDI=1.18) and then BD ([BD]=0.05 mol L⁻¹) at −80° C. was added under stirring and after different polymerization time, the reaction was quenched with prechilled methanol. Detailed analysis of the NMR spectra shows that 100% capping was obtained in 240 minutes.

### EXAMPLE 7

### Capping Polyisobutylene with a Bromoallyl Cap

The following examples show that the living polymerization of IB can be accomplished by employing methylaluminum bromides as Lewis acids.

Cationic Polymeriazation of IB in Hex/MeCl 60/40 (v/v) at −80° C. Using Mixtures of AlBr₃ and Me₃Al: Effect of Lewis Acid Concentration.

In this set of experiments the Lewis acid concentration was varied from 0.004 mol L⁻¹ to 0.01 mol L⁻¹ for AlBr₃:Me₃Al=1:1 and from 0.002 mol L⁻¹ to 0.01 mol L⁻¹ for AlBr₃:Me₃Al=2:1 mixtures in Hex/MeCl 60/40 (v/v) solvent mixture at −80° C. at [DTBP]=0.004 mol L⁻¹, [TMPCl]=0.002 mol L⁻¹, [IB]=0.25 mol L⁻¹. For AlBr₃:Me₃Al=1:2 mixture ([Me₂AlBr]=0.08 mol L⁻¹) polymerizations were carried out for different time in Hex/MeCl 60/40 (v/v) solvent mixture at −80° C. using [DTBP]=0.004 mol L⁻¹, TMPCl]=0.01 mol L⁻¹, [IB]=2.0 mol L⁻¹. The experimental results are shown in 1.

TABLE 1

| Expt. | | [LA] | Time | Conv. | Mₙ | |
|---|---|---|---|---|---|---|
| No. | AlBr₃:Me₃Al | (M) | (min) | (%) | (GPC) | PDI |
| 1 | 1:1 | 0.004 | 1 | 84.9 | 6600 | 1.05 |
| 2 | 1:1 | 0.004 | 3 | 100 | 7600 | 1.07 |
| 3 | 1:1 | 0.005 | 2 | 100 | 8200 | 1.04 |
| 4 | 1:1 | 0.01 | 2 | 100 | 8400 | 1.30 |
| 5 | 2:1 | 0.002 | 1 | 71.8 | 5600 | 1.05 |
| 6 | 2:1 | 0.002 | 4 | 100 | 8100 | 1.06 |
| 7 | 2:1 | 0.003 | 1 | 100 | 8400 | 1.37 |
| 8 | 2:1 | 0.003 | 4 | 100 | 8800 | 1.34 |
| 9 | 2:1 | 0.004 | 1 | 100 | 7800 | 1.47 |
| 10 | 2:1 | 0.005 | 2 | 100 | 10400 | 1.43 |
| 11 | 2:1 | 0.01 | 2 | 100 | 8800 | 1.57 |
| 12 | 1:2 | 0.08 | 10 | 29.0 | 4000 | 1.14 |
| 13 | 1:2 | 0.08 | 15 | 48.0 | 5700 | 1.12 |
| 14 | 1:2 | 0.08 | 40 | 93.7 | 11000 | 1.05 |
| 15 | 1:2 | 0.08 | 120 | 100 | 11900 | 1.07 |

Experimental results for the polymerization of IB in Hex/MeCl 60/40 (v/v) solvent mixture at −80° C. at [DTBP] = 0.004 mol L⁻¹. For experiments 1 to 11: [TMPCl] = 0.002 mol L⁻¹, [IB] = 0.25 mol L⁻¹, M_{n,theo} = 7200. For experiments 12 to 15: [TMPCl] = 0.01 mol L⁻¹, [IB] = 2.0 mol L⁻¹, M_{n,theo} = 11400.

Cationic Polymerization of IB in Hex/MeCl 60/40 (v/v) at −80° C. Using Mixtures of AlBr₃ and Me3Al: All Monomer In (AMI) Experiments.

A series of experiments was carried out by varying the monomer to initiator molar ratio. As shown in Table 2, the Mns are proportional to the [IB]/[TMPCl] ratio and the Mₙ values are in acceptable agreement with the theoretical Mₙs calculated with the assumption that chain transfer is absent and one molecule of TMPCl initiates one polymer chain. Thus, TMPCl/Me₃Al₂Br₃, TMPCl/MeAlBr₂ and TMPCl/Me₂AlBr initiating systems efficiently generate PIB with narrow PDI.

TABLE 2

| Expt. | | | [LA] | Time | Conv. | Mₙ | | |
|---|---|---|---|---|---|---|---|---|
| No. | [IB]/[TMPCl] | AlBr₃:Me₃Al | (M) | (min) | (%) | (GPC) | PDI | M_{n,theo} |
| 1 | 40 | 1:1 | 0.004 | 3 | 100 | 3100 | 1.08 | 2400 |
| 2 | 125 | 1:1 | 0.004 | 3 | 100 | 7900 | 1.04 | 7200 |
| 3 | 250 | 1:1 | 0.004 | 3 | 100 | 15700 | 1.11 | 14200 |
| 4 | 450 | 1:1 | 0.004 | 3 | 100 | 27800 | 1.12 | 25400 |
| 5 | 700 | 1:1 | 0.004 | 3 | 100 | 41600 | 1.13 | 39400 |
| 6 | 1100 | 1:1 | 0.004 | 3 | 100 | 61000 | 1.17 | 61900 |
| 7 | 125 | 2:1 | 0.003 | 2 | 100 | 7600 | 1.53 | 7200 |
| 8 | 250 | 2:1 | 0.003 | 2 | 100 | 15500 | 1.44 | 14200 |
| 9 | 450 | 2:1 | 0.003 | 2 | 100 | 28400 | 1.46 | 25400 |
| 10 | 700 | 2:1 | 0.003 | 2 | 100 | 38500 | 1.53 | 39400 |
| 11 | 50 | 1:2 | 0.08 | 60 | 100 | 3800 | 1.07 | 3000 |
| 12 | 200 | 1:2 | 0.08 | 60 | 100 | 12400 | 1.05 | 11400 |
| 13 | 400 | 1:2 | 0.08 | 60 | 100 | 24500 | 1.09 | 22600 |

Experimental results for the polymerization of IB in Hex/MeCl 60/40 (v/v) solvent mixture at −80° C. at [DTBP] = 0.004 mol L⁻¹. For experiments 1 to 10: [TMPCl] = 0.002 mol L⁻¹. For experiments 11 to 13: [TMPCl] = 0.01 mol L⁻¹.

Cationic Polymerization of IB in Hex/MeCl 60/40 (v/v) at 80° C. Using Mixtures of AlBr₃ and Me3Al: Incremental Monomer Addition (IMA) Experiments

The living nature of the IB polymerization with the TMPCl/Me₃Al₂Br₃, TMPCl/MeAlBr₂ and TMPCl/Me₂AlBr initiating systems was further studied by chain extension (also known as Incremental Monomer Addition (IMA)), i.e., a new feed of IB was added to the polymerization mixture. In this technique, IB was polymerized for 3, 2 and 60 minutes using AlBr₃:Me₃Al=1:1, AlBr₃:Me₃Al=2:1, and AlBr₃:Me₃Al=1:2 mixtures respectively in Hex/MeCl 60/40 (v/v) at −80° C. at [DTBP]=0.004 mol L⁻¹. For AlBr₃:Me₃Al=1:1 ([Me₃Al₂Br₃]=0.004 mol L⁻¹) and AlBr₃:Me₃Al=2:1 ([MeAlBr₂]=0.003 mol L⁻¹) mixtures, [TMPCl]=0.002 mol L⁻¹, [IB]=0.25 mol L⁻¹ and for AlBr₃:Me₃Al=1:2 ([Me₂AlBr]=0.08 mol L⁻¹) mixture [TMPCl]=0.01 mol L⁻¹, [IB]=2.0 mol L⁻¹ were used. Then a second and subsequently a third feed of IB were added to a polymerization system under stirring. The results are summarized in Table 3. The additional IB smoothly polymerized without a noticeable decrease in the polymerization rate, the M, increased, and the molecular weight distribution stayed narrow. Thus, the polymerization of IB by TMPCl/Me₃Al₂Br₃, TMPCl/MeAlBr₂ and TMPCl/Me₂AlBr initiating systems in Hex/MeCl 60/40 (v/v) at −80° C. is living, as chain transfer and termination are undetectable.

TABLE 3

| Expt. | | [LA] | Time | Conv. | Mₙ | | |
|---|---|---|---|---|---|---|---|
| No. | AlBr₃:Me₃Al | (M) | (min) | (%) | (GPC) | PDI | M_{n,theo} |
| 1 | 1:1 | 0.004 | 3 | 100 | 8400 | 1.05 | 7200 |
| 2 | 1:1 | 0.004 | 3 + 3 | 200 | 23500 | 1.07 | 21200 |
| 3 | 1:1 | 0.004 | 3 + 3 + | 300 | 34600 | 1.12 | 35200 |
| | | | 3 | | | | |
| 4 | 2:1 | 0.003 | 2 | 100 | 7600 | 1.53 | 7200 |
| 5 | 2:1 | 0.003 | 2 + 2 | 200 | 19400 | 1.56 | 21200 |
| 6 | 2:1 | 0.003 | 2 + 2 + | 300 | 30800 | 1.52 | 35200 |
| | | | 2 | | | | |
| 7 | 1:2 | 0.08 | 60 | 100 | 12400 | 1.05 | 11400 |
| 8 | 1:2 | 0.08 | 60 + 60 | 200 | 23700 | 1.30 | 22600 |

Experimental results for the polymerization of IB in Hex/MeCl 60/40 (v/v) solvent mixture at −80° C. at [DTBP] = 0.004 mol L⁻¹. For experiments 1 to 6: [TMPCl] = 0.002 mol L⁻¹, [IB]₁ = 0.25 mol L⁻¹, [IB]₂ = [IB]₃ = 0.5 mol L⁻¹. For experiments 7 to 8: [TMPCl] = 0.01 mol L⁻¹, [IB]₁ = [IB]₂ = 2.0 mol L⁻¹.

Capping of PIB⁺ with 1,3-Butadiene in Hex/MeCl 60/40 (v/v) at −80° C. Using 1:1 Mixtures of AlBr₃ and Me₃Al.

To study the capping reaction of PIB⁺ cation with BD, first IB was polymerized for 3 minutes using AlBr₃:Me₃Al=1:1 in hexanes/MeCl 60/40 (v/v) at −80° C. at [DTBP]=0.004 mol L⁻¹, [TMPCl]=0.002 mol L⁻¹, [IB]=0.25 mol L⁻¹ (conversion of IB=100%, M_{n,GPC}=8400, M_{n,NMR}=8500, PDI=1.05). Then the capping agent [BD]=0.04 mol L⁻¹ at −80° C. was added to the reaction mixture under stirring and after different polymerization time, the reaction was quenched with methanol. The ¹H NMR spectra confirmed the formation of 1:1 adduct; PIB-BD-Br in 30 min.

Capping of PIB⁺ with 1,3-Butadiene in Hex/MeCl 60/40 (v/v) at −80° C. Using 1:1 Mixture of AlBr₃ and Me₃Al at [TMPCl]=0.002 mol L⁻¹, [IB]=0.08 mol L⁻¹.

The capping reaction of PIB⁺ cation with BD was verified in Hex/MeCl 60/40 (v/v) at −80° C. using 1:1 Mixture of AlBr₃ and Me₃Al ([Me₃Al₂Br₃]=0.004 mol L⁻¹) at [TMPCl]=0.002 mol L⁻¹, [DTBP]=0.004 mol L⁻¹, [IB]=0.08 mol L⁻¹, and [BD]=0.04 mol L⁻¹. From GPC M_{n,GPC}=3100 was calculated for this polymer, which is in good agreement with the molecular weights obtained from NMR (Mₙ=3000). Detailed analysis of the NMR spectra of the product showed 100% capping and the formation of 1:1 adduct PIB-BD-Br.

### EXAMPLE 8

### High Reactivity of the Bromoallyl Functionality

300 mg of PIB-BD-Br (2 mol L⁻¹) was taken in a 25 mL culture tube. 117 mg hexamethylenediamine (HD, 20 mol L⁻¹), 21 mg (10 mol L⁻¹) of MgO (base for binding HCl) and 0.05 mL of THF were added to the culture tube under nitrogen and tightened with Teflon-lined caps. The reaction mixture was refluxed (65° C. in the oil bath) under stirring for different times.

After predetermined time, the THF was stripped off under reduced pressure. The residue is taken up in 20 ml of hexane and passed through a column packed with Al₂O₃. The polymer was recovered and purified four times by reprecipitation from hexanes/methanol. Finally, the polymer was dried at 35° C. in the vacuum oven for 12 h. Virtually quantitative conversions were obtained.

Detailed analysis of the NMR spectra shows that virtually quantitative reaction (Scheme 2) in 30 minutes. 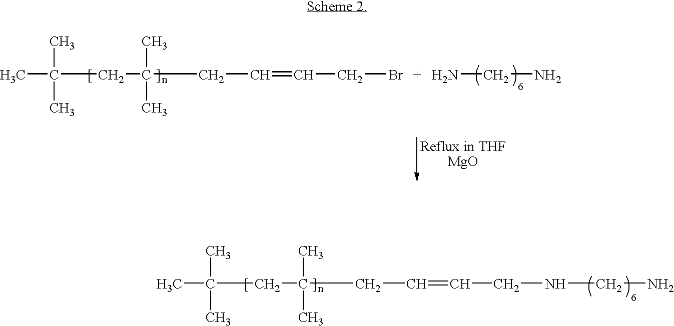
Equivalents

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of synthesizing an endcapped polymer, comprising:
reacting in a solvent a cationic living polymer with an optionally substituted conjugated diene as an endcapping reagent, whereby the solvent causes termination by halogenation to be faster than the addition of additional molecules of the conjugated diene, thereby producing an endcapped polymer having a halogenated endcap group.

2. The method of claim 1, wherein termination by halogenation is at least 10-fold faster than the addition of additional molecules of the conjugated diene.

3. The method of claim 1, wherein termination by halogenation is at least 100-fold faster than the addition of additional molecules of the conjugated diene.

4. The method of claim 1, wherein termination by halogenation is at least 1000-fold faster than the addition of additional molecules of the conjugated diene.

5. The method of claim 1, wherein the solvent comprises at least one component having a dielectric constant less than 9.

6. The method of claim 5, wherein the solvent comprises at least one component having a dielectric constant less than 7.

7. The method of claim 1, wherein the solvent comprises a mixture of solvents having a polar solvent with a dielectric constant equal to or higher than 9 and a nonpolar solvent with a dielectric constant lower than 6.

8. The method of claim 1, wherein the solvent is selected from one or more of hexane, cyclohexane, methylcyclohexane, methylchloride, n-butyl chloride, dichloromethane, toluene, and chloroform.

9. The method of claim 1 wherein the cationic living polymer is polyisobutylene.

10. The method of claim 1, wherein the cationic living polymer is a C₄ to C₇ isomonoolefin polymer.

11. The method of claim 1 wherein the endcap group is an optionally substituted haloallyl group.

12. The method of claim 11 wherein the endcap group is a chloroallyl group.

13. The method of claim 11 wherein the endcap group is a bromoallyl group.

14. The method of claim 1, further including the step of producing the cationic living polymer by reacting a cationically polymerizable monomer in the presence of a coinitiator.

15. The method of claim 11, wherein the coinitiator is one or more of BCl₃, TiCl₄, and organoaluminum halides.

16. A method of synthesizing an endcapped polymer, comprising
reacting in a solvent a cationic living polymer of formula (I) 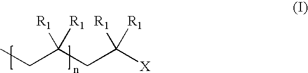
with an optionally substituted conjugated diene of formula (II) as an endcapping reagent in the presence of a Lewis acid, 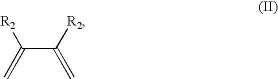
whereby the solvent causes termination by halogenation to be faster than the addition of additional molecules of the conjugated diene, thereby producing an endcapped polymer of formula (III) having a halogenated endcap group 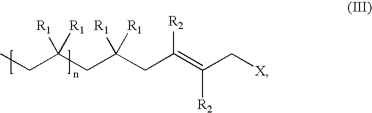
wherein
n is not less than 2,
X is a halogen,
R₁ for each occasion is independently H or a C1-C4 alkyl, and
R₂ for each occasion is independently H, a halogen, —CH₂X, —CHX₂, —CX₃, —C≡N, —NO₂.

17. The method of claim 16, wherein termination by halogenation is at least 10-fold faster than the addition of additional molecules of the conjugated diene.

18. The method of claim 16, wherein termination by halogenation is at least 100-fold faster than the addition of additional molecules of the conjugated diene.

19. The method of claim 16, wherein termination by halogenation is at least 1000-fold faster than the addition of additional molecules of the conjugated diene.

20. The method of claim 16, wherein the solvent comprises at least one component having a dielectric constant less than 9.

21. The method of claim 20, wherein the solvent comprises at least one component having a dielectric constant less than 7.

22. The method of claim 16, wherein the solvent comprises a mixture of solvents having a polar solvent with a dielectric constant equal to or higher than 9 and a nonpolar solvent with a dielectric constant lower than 6.

23. The method of claim 16, wherein the solvent is selected from one or more of hexane, cyclohexane, methylcyclohexane, methylchloride, n-butyl chloride, dichloromethane, toluene, and chloroform.

24. The method of claim 16 wherein the cationic living polymer of formula (I) is polyisobutylene.

25. The method of claim 16, wherein the cationic living polymer of formula (I) is a C₄ to C₇ isomonoolefin polymer.

26. The method of claim 16, wherein X is Cl or Br.

27. The method of claim 16, further including the step of producing the cationic living polymer of formula (I) by reacting a cationically polymerizable monomer in the presence of a coinitiator.

28. The method of claim 27, wherein the coinitiator is one or more of BCl₃, TiCl₄, and organoaluminum halides.

29. A method of synthesizing an endcapped polymer, comprising
reacting a polymer of formula (IV) 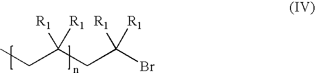
with an optionally substituted conjugated diene of formula (II) as an endcapping reagent in the presence of a Lewis acid, 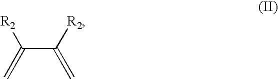
thereby producing an endcapped polymer of formula (V) having a halogenated endcap group, 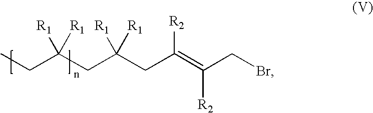
wherein
n is not less than 2, and
R₁ for each occasion is independently H or a C1-C4 alkyl, and
R₂ for each occasion is independently H, a halogen, —CH₂X, —CHX₂, —CX₃, —C≡N, —NO₂.

30. The method of claim 29 wherein the cationic living polymer of formula (IV) is polyisobutylene.

31. The method of claim 29, wherein the cationic living polymer is a C₄ to C₇ isomonoolefin polymer.

32. The method of claim 29, further including the step of producing the cationic living polymer of formula (IV) by reacting a cationically polymerizable monomer in the presence of a coinitiator.

33. The method of claim 32, wherein the coinitiator is one or more of AlBr₃, Me₃Al₂Br₃, MeAlBr₂, and Me₂AlBr.
